(19) United States
(12) Patent Application Publication
(10) Pub. No.: US 2013/0166370 A1
(43) Pub. Date: Jun. 27, 2013

(54) REWARDS SYSTEM AND METHOD

(71) Applicants: Jay C. Weber, Palo Alto, CA (US); Stuart M. Butler, Blackrock (IE); Michael P. Geraghty, Palo Alto, CA (US)

(72) Inventors: Jay C. Weber, Palo Alto, CA (US); Stuart M. Butler, Blackrock (IE); Michael P. Geraghty, Palo Alto, CA (US)

(73) Assignee: Sohalo, Palo Alto, CA (US)

(21) Appl. No.: 13/335,910

(22) Filed: Dec. 22, 2011

(51) Int. Cl. G06Q 30/02

(52) U.S. Cl. 705/14.27

(57) ABSTRACT

A rewards system and method are provided in which the system has a reward defining engine and a rewards earning engine that are able to define a reward and allow users to earn a reward.

### FIELD

The disclosure relates generally to a rewards system and method that may be integrated into another software application.

### BACKGROUND

Most businesses from small business mom & pop shops to larger brands are challenged to connect with their customers and attract new ones using social media. Traditional marketing tools are insufficient at addressing the rapid rise of social media (mainly Facebook) as a marketing channel and new social media companies have typically focused on niche media management and analytics tools. In addition, the market for delivering loyalty points to a long tail of merchants has been daunting due to a time to deploy, customize and the overall cost of ownership. Most SaaS companies have focused on eCommerce shops, CMS, payments, or analytics to assist web sites.

The social commerce ecosystem of companies can be broken into several segments such as:
Gaming
Media (CMS)
Analytics
eCommerce
Payments
Loyalty

While some of these segments overlap, the companies that have surfaced to offer solutions to brands have largely focused on games, analytics and payment currencies. Social plug-in/media companies like Involver, Buddy Media, and Wildfire have focused on tools that manage cross-platform rich-content management from Blogs, website, Twitter and Fan pages. Some businesses have also expanded to promote 3rd party apps and solutions for contests.

Few companies have focused on rewarding behavior in the form of a white-label platforms that can scale. For example, Shopkick and Foursquare have built their own social networks (non-Facebook) that reward only check-ins using geo-location services in store or from the mobile client itself However, these non-Facebook social networks have limited scope and a limited scope of rewards.

It is desirable to provide a rewards system that has broader scope and that is not limited to any specific social network, allows a plurality of reward rules to be created and listens to a social graph to record instant reward earning transactions. The above would solve a real-world challenge for many businesses who are spending large sums of money attempting to acquire customers through traditional marketing funnels. The above desirable system lowers the cost of acquisition per customer compared to other paid marketing techniques (paid search, ads, etc) and customers at the same time enjoy instant rewards that can be used for redeeming real goods and services.

Social gaming is very popular and the gaming community earn points in most games for achieving levels in the games but there are no tangible real rewards for achievement other than social status amongst peers. It is desirable to provide a system that provides rewards to user for gaming as well as other everyday activities. There are also fan page based solutions like RootMusic are vertically focused on bands and providing event driven tools to but not loyalty or rewards.

Thus, it is desirable to provide a rewards system and method that overcomes the limitations of current system and methods and it is to this end that the disclosure is directed.

### BRIEF DESCRIPTION OF THE DRAWINGS

FIG. 1 illustrates an implementation of a rewards system that may include reward-defining engine (RDE) and a reward-earning engine (REE);

FIG. 2 illustrates a method for rewards that includes a process to determine rewards and act on matched rewards;

FIG. 3 illustrates a method for rewards that includes a process of matching rules against information from the Semantic Graph;

FIG. 4 illustrates an alternative “asynchronous” architecture of the rewards system that interacts with both the Semantic Graph and with a rewards end-user;

FIG. 5 illustrates another embodiment of the rewards system that has another mechanism for triggering rewards through participation of an “Affiliated Service”;

FIG. 6 illustrates an example of a type of REE rule known as an “Aggregate Friend Rule”; and

FIGS. 7A and 7B illustrate an example of a database schema that is used to support the rewards system.

### DETAILED DESCRIPTION OF ONE OR MORE EMBODIMENTS

The disclosure is particularly applicable to a computer implemented rewards system and method illustrated and described below and it is in this context that the disclosure will be described. It will be appreciated, however, that the system and method has greater utility since the system can be implemented in other manners that are within the scope of the disclosure and the system can be implemented using other computer architectures that are within the scope of the disclosure.

The system can assign global reward behaviors and retarget customers, lowering the cost of acquisition per customer compared to other paid marketing techniques (paid search, ads, etc). Typically a loyalty currency value will be a fraction of the cost of delivering a discount on the price of a product (i.e. average air mile costs $0.001) and customers at the same time enjoy instant rewards that can be used for redeeming real goods and services. The engines of the system may also deliver a perpetual point-earning interface for a consumer and brand to engage based on everyday activities and provide economies of scale as a white-label, multi-customer capability to reach many brands that want to customize our reward behavior engine to match niche semantic patterns of consumer behavior on a graph, such as the Facebook graph in one embodiment.

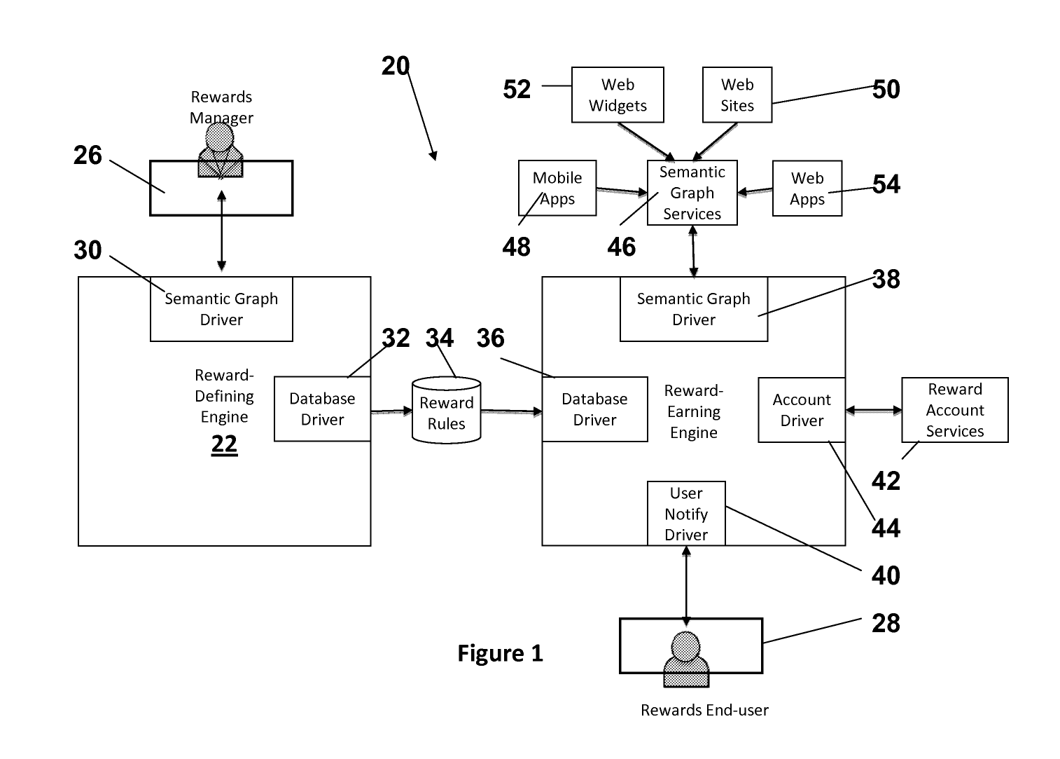

FIG. 1 illustrates an implementation of a rewards system 20 that may include reward-defining engine (RDE) 22 and a reward-earning engine (REE) 24. The system may be used by a rewards manager who accesses the system 20 using a rewards manager computing device 26 and a rewards end-user who accesses the system 20 using a rewards end user computing device 28. The engines 22, 24 may each be implemented as a plurality of lines of computer code that are executed by a processing unit of a computer, such as a server computer, that hosts one or both engines. The engines 22, 24 may be hosted on the same computer or on different computers that are linked to each other and communicate with each other. The computing devices 26, 28 may access and communicate with the system over a link, such as a wired or wireless link such as the Internet, Ethernet, a wireless digital data network, a wireless network, a computer network and the like. Each computing device 26, 28 may be a processing unit based device with memory, a persistent storage device, a display and connectivity (wireless circuits or the like) to be able to interact with the system 20. For example, each computing device 26, 28 may be smartphone device (Apple iPhone, RIM Blackberry, Android based devices), a tablet computer, a personal computer, a cellular phone and the like.

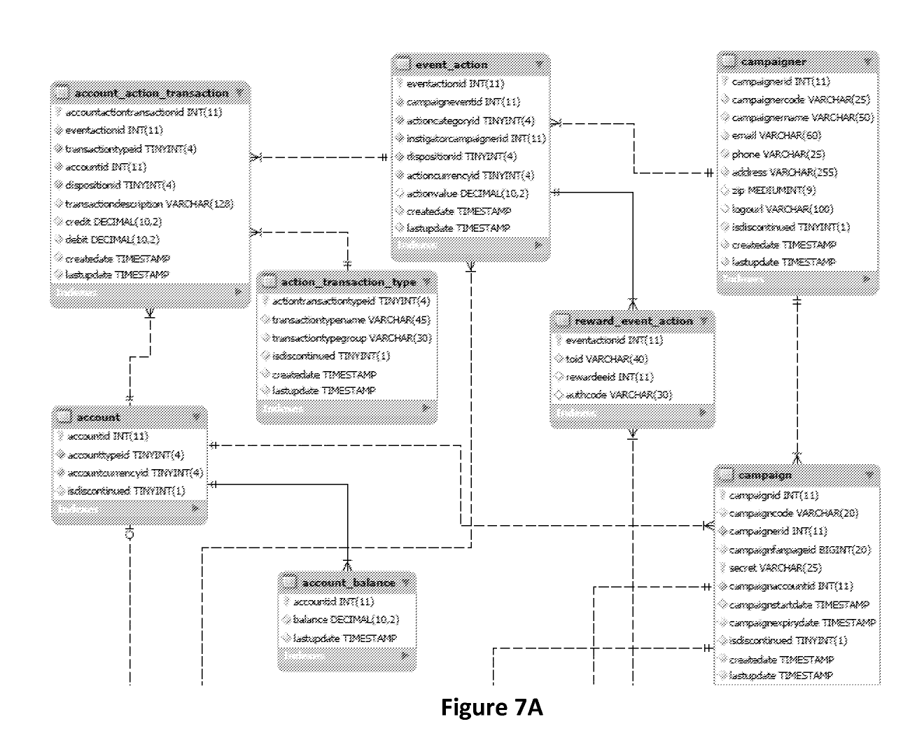

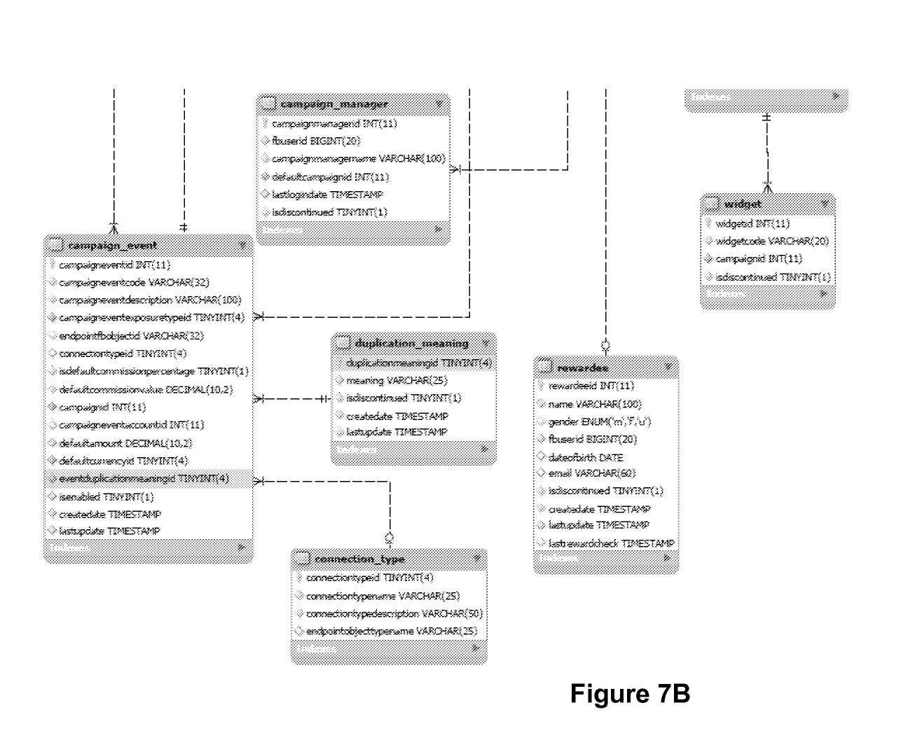

The Rewards Manager, using the computing device 26, uses the reward-defining engine (RDE) 22 to define reward rules and the reward-earning engine (REE) 24 applies those rules to rewards end-users using the computing device 28 to determine which users get what rewards. In one embodiment, the RDE 22 is a Web application including a user interface that presents the user with a form for defining the conditions that lead to rewards, as well as the kind and amount of the rewards. Thus, the computer that hosts the RDE 22 may have a web server (software or hardware based) that serves web pages from the web application to the user and receive information from the user for web page forms. The RDE 22 may contain a semantic graph driver (SGD) 30 that determines the kinds of rules, the parameters for each kind of rule, and the terminology for a particular Semantic Graph. In one embodiment, the Semantic Graph is Facebook and therefore the SGD determines the connection and object types supported by Facebook APIs (likes, friendships, etc.) In another embodiment, the Semantic Graph is Twitter and the SGD relates to accounts, followers, tweets, retweets, etc. Other embodiments using systems that encode user behaviors or the effects of user behaviors, and provide APIs for third-parties to access that information include YouTube, Google+, LinkedIn, eBay, and Stack Overflow. The RDE 22 also may have a database driver 32 that encodes the Rewards Manager's rules into a database schema of a Reward Rules store 34. In one embodiment, the Rewards Rules store 34 may be a relational database with tables representing Facebook users, marketing campaigns, campaign events (rules), connection types, and object ids (an example of which is shown in FIGS. 7A and 7B.)

The REE 24 loads these rules from the store 34 using a Database Driver 36. To determine whether a particular user has earned a reward, the REE uses a Semantic Graph Driver (SGD) 38 to retrieve information from the Semantic Graph pertinent to the reward rules, and then matches that information directly against the rewards rules. For example, here are some of the connections that Facebook represents in their Semantic Graph and makes available through their Graph API:

| From-object Type | Connection | To-object Type |
|---|---|---|
| User | Friends | User |
| User | Likes | (Fan) Page |
| User | Checkins | Checkin-instance |
| | | (Place Page) |
| User | Listens | Music |
| User | Watches | Video |
| User | Answers | Poll/Quiz Questions |
| User | Joins | Group |
| User | Reads | News |

Thus the rules each specify a particular connection that the current end-user must have to a particular object, e.g., having liked a Brand's fan page, or done a checkin at a particular store's place page. For each match, the REE 24 notifies each Rewards End-user 28 using a User Notify Driver 40 and notifies a Reward Account Services (RAS) 42 via an Account Driver 44.

A Semantic Graph Services 46 of the system accumulate information for each semantic graph from a variety of sources including users using Mobile Apps 48, Web sites focused on the Semantic Graph 50, Web widgets on Web sites not focused on the Semantic Graph 52, and Web apps 54 implemented on the Semantic Graph platform. All of these sources may be provided by the Semantic Graph proprietors or third-parties.

In one embodiment, the REE 24 is part of a Facebook® application that is accessed directly by URL and/or is embedded on a Facebook Page as a Tab. The Semantic Graph in this embodiment is Facebook so the SGD 30, 38 uses the Facebook Graph API (FGA) to retrieve information about connections between the user and Facebook objects. The User Notify Driver 40 modifies the user interface of the Facebook application to notify the user about an earned reward. For example, upon visiting the Rewards tab of the Facebook fan page for the Brand offering the reward, if the rules match Semantic Graph information from the SGD as above, the content in the fan-page tab would include “Congratulations, you have won 10 points for liking this fan page.” This user interface can also include information about past rewards (e.g., as a “Rewards History” ledger) and other potential rewards as descriptions and hyperlinks. In one embodiment, the rewards consist of some number of points or credits in a private or public currency. The Account Driver 44 uses an online API to contact the Reward Account Services 42 to request that the user's account be credited for the amount of the reward.

Other envisioned embodiments of the rewards system include implementations in which the Semantic Graph is another social network besides Facebook; where the User Notify Driver uses asynchronous messaging to notify the end-user; where the Reward Account Services are locally hosted; where Semantic Graph information is locally cached; and where the Account Driver batches requests to the Reward Account Services.

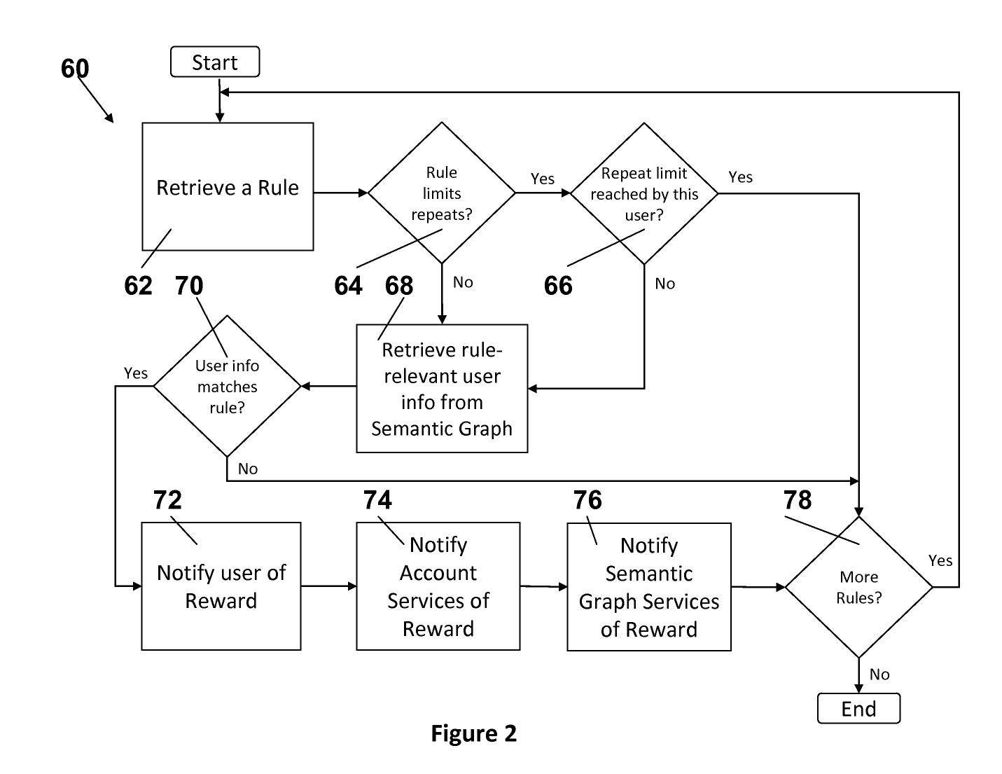

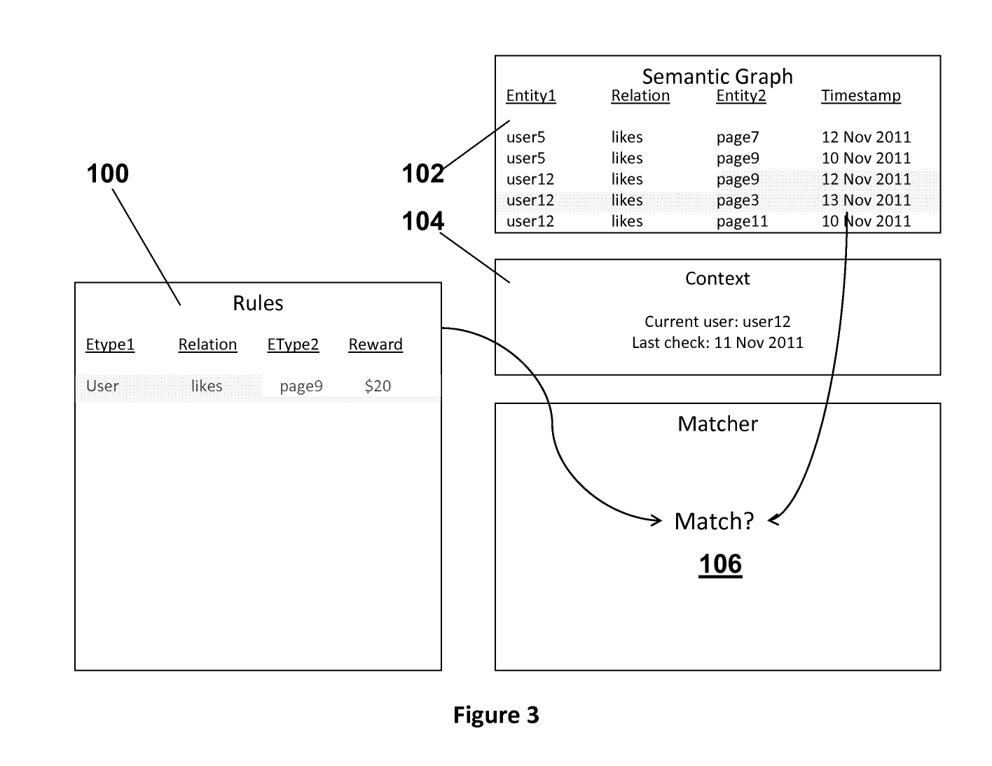

FIG. 2 illustrates a method 60 for rewards that includes a process to determine rewards and act on matched rewards. For example, FIG. 2 shows the logic inside of the REE to process each rule and act on matched rewards based on a particular rule for a particular user, although the method can be carried out on other computer systems. In the method, the REE retrieves a rule (62) and determines whether the rule may apply to the current user by determining whether this rule limits the number of times it may be repeated (64), and if so, looking at the user's reward history to determine if that number of times has already been met (66). If the repeat limit has not been reached or the repeat limit has not been reached by this user, the REE will retrieve enough information from the Semantic Graph to determine whether the rule matches the current user (70) as detailed below in FIG. 3. If there is a match, then the REE notifies both the end-user (72) and Account Services (74). Optionally, if the Semantic Graph Services support it, the REE may notify the Semantic Graph Services (76) about the reward.

As shown in FIG. 2, if the repeat limit is met, the user does not match the particular rule and/or the rule has been matched and the notifications have occurred, the REE determines if there are more rules to be checked against the particular user (78) and then retrieve a new rule (62) if there are additional rules or the process is completed. In one embodiment, Facebook is the Semantic Graph and the REE uses the Facebook Graph API to POST an Open Graph 2.0+ “earn” action of a “reward” object consisting of a currency and an amount.

FIG. 3 illustrates a method for rewards that includes a process of matching rules 100 against information from the Semantic Graph 102. In particular, a rule 100 in the store 34 in FIG. 1 (a user who likes page 9 gets a $20 reward rule) is matched by a matcher 106 (that is part of the REE) based on a context 104. An important concept is how the REE uses the context 104 of the current user and the set of rules 100 to make efficient queries of the Semantic Graph 102. That is, one strategy would be to query the Semantic Graph for all information pertaining to the current user; this would be a reasonable strategy for a Semantic Graph with very limited information about each user but in larger Semantic Graphs (like Facebook) such a query would be low-performance and produce a prohibitively-large set of results to process. The rule may include a first entity (a user who can earn a reward), a second entity (an item/person, etc., such as a Facebook page based on which a reward may be granted), relation between the first and second entity that determined if a rewards should be granted, such as likes on Facebook) and the reward amount. Each rule also may have a repeat limit that limits the number of times that a user can get a particular reward.

The REE includes the use of three pieces of information to limit the Semantic Graph query: 1) the particular user identifier; 2) the scope of a particular rule (the types of entities and relations involved), and 3) the timestamp of the last query for the particular user and rule (which are known as the context.) Depending on the kinds of queries supported by the Semantic Graph, the results may correspond 1-1 with earned rewards or may require additional filtering. For example, FIG. 3 shows the results of a query for all the Entities liked by user 12 since the last check of 11 Nov. 2011; the matcher would then look through those results for an Entity 2 of page 9 and two users (user 5 and user 12) would be matched. In one embodiment, the Semantic Graph is Facebook and the relations include the Friend connection of Facebook's Social Graph, the Likes connection of Facebook's Open Graph 1.0+, as well as the app-namespace specific Actions of Facebook's Open Graph 2.0+. In one implementation, the REE is a PHP class using a MySQL database and the Facebook graph API as detailed in Appendix A which is incorporated herein by reference.

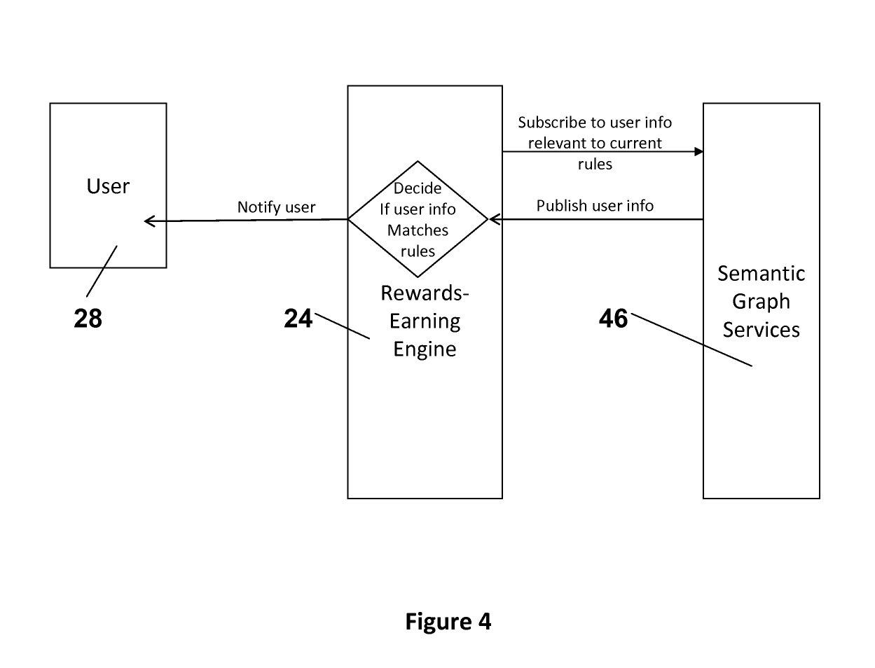

FIG. 4 illustrates an alternative “asynchronous” architecture of interacting both with the Semantic Graph and with the Rewards end-user. In this architecture, the REE 24 operates asynchronously by requesting, from the Semantic Graph Services (SGS) 46, a subscription to all information pertaining to the current rules and for all registered users. That way, when pertinent user information changes, the SGS 46 notifies the REE 24 about changes to user information. In such a case, the REE 24 compares the changes to the current set of rules and determines whether new rewards have been earned, and if so, notifies the user as shown in FIG. 4 via asynchronous messaging or stores the information about earned rewards for the next synchronous user interaction (e.g., the next time the user visits the Rewards tab of the fan page, a special social network app, or a Rewards website). In one implementation, the Semantic Graph Services 46 is Facebook's Graph API and the Subscribe/Publish mechanism that is part of the rewards earning engine 24 is Facebook's “Real-Time Updates” API.

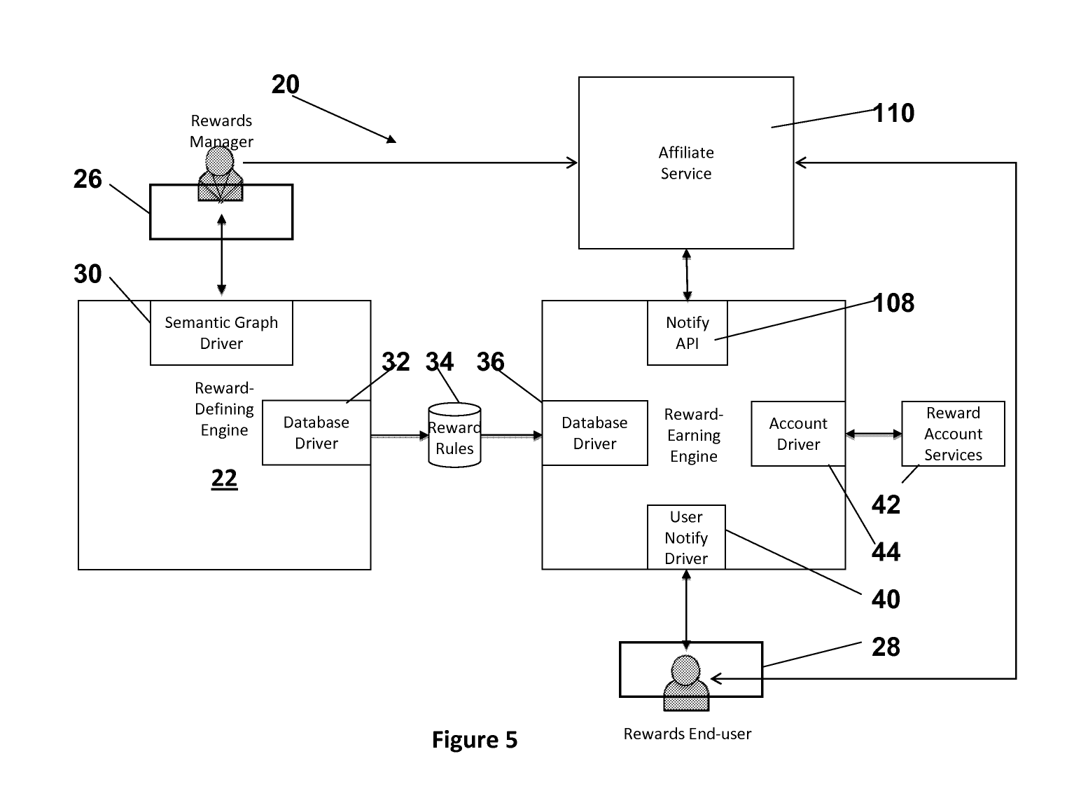

FIG. 5 illustrates an alternative embodiment for triggering rewards through participation of an “Affiliated Service” 110, which in one embodiment would be a third-party website. The idea is that users could earn rewards by performing certain actions on that website like making purchases, booking travel, watching promotional videos, etc. The system does this by having the website notify our REE 24 of users performing rewardable events via a Notify API. In one embodiment, the Notify API uses a REST (URL-based) API with two main entry points, CheckReward and AuthReward.

CheckReward is called by the service/website to check if a reward is still valid and active, e.g., whether the Reward Rule still has budget, or whether the Rewards Manager has turned off the Reward Rule. For example, requesting the URL:

http://ree.sohalo.com/rest/checkReward.php?fromId=RM02&toId=CUST07&campaignId=CAM13

would ask if there is a valid and active rule pertaining to the Rewards Manager RM02's rewards campaign CAM13, an if so, return the reward amount and currency. Then the website would display the opportunity to receive the reward and provide instructions on how to claim it (in one embodiment, the user can claim it through a link to a facebook app or page). The CheckReward parameters may include:
fromId—the ID of the reward giver, values determined by the REE (this parameter is not optional and there is no default)
told—the ID of the reward getter, values determined by the reward manager (this parameter is not optional and there is no default)
campaignId—the ID of the action triggering the reward, values determined by reward manager (this parameter is not optional and there is no default)
   and for the non-error return values:
amount—the number of points in the reward
currency—the currency of the reward as a three-letter acronym (TLA), defined by the REE

The website/service requests an AuthReward URL in order to tell the REE 24 that the reward is authorized, and as such, is necessary before the REE will provision the reward. In an example of one embodiment, requesting the URL:

http://ree.sohalo.com/rest/authReward.php?fromId=RM02&toId=CUST07&campaignId=CAM13&amount =2&currency=FBC&signature=GHY653GF8KWM99

would state that the user CUST07 has earned a reward of 2 Facebook Credits from Rewards Manager RM02 for performing the action described by CAM13. The signature parameter is a digital signature of the other parameters, in order to verify that this request is coming from an authenticated entity. The AuthReward parameters may include:
fromId—the ID of the reward giver, values determined by the REE (this parameter is not optional and there is no default)
told—the ID of the reward end-user, values determined by the reward manager (this parameter is not optional and there is no default)
campaignId—the ID of the action triggering the reward, values determined by reward manager (this parameter is not optional and there is no default)
signature—a digital signature of the concatenation of the other 5 parameters plus the reward-manager's secret
amount—the number of reward points to authorize (optional, default supplied by REE rule)
currency—the currency of the reward as a TLA as defined by the REE (optional, default supplied by the REE Rule)
   and AuthReward returns an unguessable code, or error. The code functions as a receipt for the request, useful for auditing purposes.

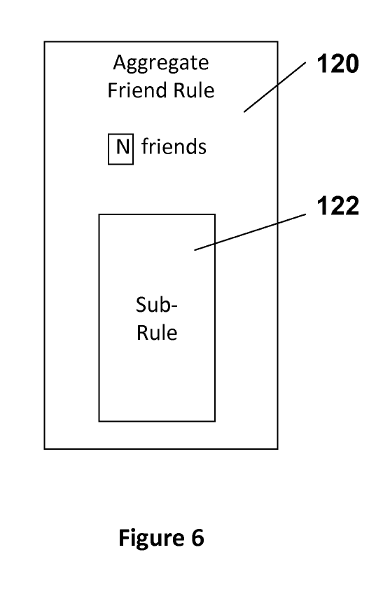

FIG. 6 shows a type of REE rule that is an “Aggregate Friend Rule” 120. That is, a Rewards End-user can earn a reward for having some social-networking friends that have performed a Sub-Rule 122. Such a rule is defined in the RDE 22 by the number of friends and a reference to another rule. For example, having 10 friends Like a particular Facebook fan-page (and earn a reward for doing so), or 5 friends do a mobile check-in a particular location.

FIGS. 7A and 7B illustrate an example of a database schema that is used to support the rewards system. The database schema may include a campaign table that contains information about a campaign when a campaigner creates a campaign which in one embodiment is promoted on a given facebook fanpage stored in the campaignfanpageid column. Each campaign has one or more campaign_managers to promote and manage the campaign. The duration of the campaign may be defined by assigning values to the campaign table columns campaignstartdate and campaignenddate. (Start and end dates/times could also be attached to individual campaign events.) The credit to fund the overall campaign is drawn from an account, set in the campaigneventaccountid column.

The database schema also may include a campaign_event table in which a campaign manager uses the Reward-Defining Engine (RDE) to create one or more Reward Rules for a given campaign. Each individual rule is represented by a tuple in the campaign_event table. In the preferred embodiment, a user is rewarded for forming a connection with the facebook object defined in the endpointfbobjectid column. The connection type is an element from the set of types defined in the connection_type table (liking a fanpage, liking a fanpage wall post, checking in to a specific place etc.). The campaign manager sets the reward value and reward currency which are stored the defaultamount and defaultcurrencyid columns respectively. The campaign manager may also restrict how many times the user may be rewarded for forming the given connection, via the eventduplicationmeaningid column. The duplicationmeaningid is an element of the set of meanings defined in the duplicationmeaning table (allow, reject or replace etc.). The credit to fund a campaign event is drawn from an account recorded in the campaigneventaccountid column. When there is insufficient credit remaining to honor a given reward (this is known apiori), the associated campaign_event is excluded by Rewards Earning Engine. A campaign manager is free to move credit between the parent and/or child accounts as appropriate; each campaign has an overall budget which can be distributed and redistributed among the associated campaign_event sub-accounts. Individual campaign_events can be paused and re-started by setting a boolean flag in the isenabled column.

The database schema may also include a rewardee table and each visitor to the campaign fanpage is represented as a tuple in the rewardee table. Each rewardee has a rewardeeaccountid which records the rewards credit to the user for this campaign. Individual account transactions are represented as account_action_transactions.

The database schema may also include a reward_event_action table so that when a reward is credited to a rewardee, a tuple is added to the event_action table with a related tuple being added to the reward_event_action. Each reward_event_action has a set of associated account_action_transactions to represent a debit from the campaign_event account and a credit to the rewardee's account.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A rewards system, comprising:
a store containing a plurality of reward rules, each reward rule having a user who can receive a reward, a second entity, a relation between the user and the second entity that justifies a reward and a reward value;
a computing device of the user; and
a computer implemented reward earning engine that interacts with the computing device of the user, the rewards earning engine retrieves a reward rule from the store, retrieves a set of user information from a semantic graph wherein the retrieval is limited by a context of the user and determines if there is a match between the reward rule and the set of user information, and notifies the computing device of the user of a reward if there is a match between the reward rule and the set of user information.

2. The system of claim 1 further comprising a computer implemented rewards defining engine coupled to the store, rewards defining engine allows a rewards manager to create a new reward rule that is stored in the store.

3. The system of claim 1, wherein the semantic graph is Facebook and the reward earning engine is a Facebook application.

4. The system of claim 1, wherein the context of the user in one or more of a particular user identifier, a scope of the reward rule and a timestamp of a last query for the user.

5. The system of claim 1, wherein the reward value is one of points and credits.

6. The system of claim 2, wherein the rewards defining engine is a web application.

7. The system of claim 6, wherein the reward earning engine is a Facebook application.

8. The system of claim 1, wherein the reward earning engine one of asynchronously messages the user about a reward and stores the reward message until a next synchronous user interaction occurs.

9. The system of claim 1 further comprising an affiliate service wherein the user performs an action on the affiliate service to earn a reward.

10. The system of claim 1, wherein the plurality of reward rules includes an aggregate friend rule wherein the user earns rewards for a set of friends performing an action in a sub-rule.

11. A method for rewarding a user using a computer implemented rewards system that has a rewards defining engine and a rewards earning engine, the method comprising:
retrieving, by a rewards earning engine, a reward rule from a store, the reward rule having a user who can receive a reward, a second entity, a relation between the user and the second entity that justifies a reward and a reward value;
retrieving, by the rewards earning engine, a set of user information from a semantic graph wherein the retrieval is limited by a context of the user;
determining, by the rewards earning engine, if there is a match between the reward rule and the set of user information; and
notifying, by the rewards earning engine, the user of a reward if there is a match between the reward rule and the set of user information.

12. The method of claim 11 further comprising creating, using a computer implemented rewards defining engine, a new reward rule and storing the new reward rule into a store that is accessible by the reward earning engine.

13. The method of claim 11, wherein the semantic graph is Facebook and the reward earning engine is a Facebook application.

14. The method of claim 11, wherein retrieving a reward rule further comprises determining if the reward rule limits repeats.

15. The method of claim 14, wherein retrieving a reward rule further comprises determining if the user has exceeded a repeat limit of the rule.

16. The method of claim 11, wherein the context of the user in one or more of a particular user identifier, a scope of the reward rule and a timestamp of a last query for the user.
